(19) United States
(12) Patent Application Publication
(10) Pub. No.: US 2024/0334070 A1
(43) Pub. Date: Oct. 3, 2024

(54) Image Processing for Preventing Flickering

(71) Applicant: Bank of America Corporation, Charlotte, NC (US)

(72) Inventors: Yogi Ahuja, Warwick, PA (US); Shashi Rao, McKinney, TX (US)

(73) Assignee: Bank of America Corporation, Charlotte, NC (US)

(21) Appl. No.: 18/126,829

(22) Filed: Mar. 27, 2023

(51) Int. Cl. H04N 23/745; G06T 7/11; G09G 5/36

(52) U.S. Cl. CPC H04N 23/745; G06T 7/11; G09G 5/36; G09G 2320/0247

(57) ABSTRACT

An image processing platform may be configured to reduce user interface screen flickering and improve page loading speed. An image processing platform may process images based on determined image complexity. A decision engine may determine the number of image splits and type of parallel processing for an image. The determined image complexity may be based on a determined image complexity score. The system may include machine learning in connection with the decision engine results.

### BACKGROUND

Large enterprise organizations provide many different products and/or services. To support these complex and large-scale operations, a large organization may own, operate, and/or maintain many different computer systems that service different internal users and/or external users in connection with different products and services. Many of these different computer systems have connected user interfaces to display and receive data input from users. Complex images displayed on these user interfaces reduce page load speed and causes user interface screen flickering. This reduced page loading speed and user interface screen flickering is inconvenient for all users and for some users with photosensitivity issues may cause discomfort and/or trigger potential health issues. In addition, reducing user interface screen flickering is consistent with The Americans with Disabilities Act (“ADA”) accessibility guidelines and World Wide Web (W3C) criterion and guidelines. As such, a need has been recognized to reduce user interface screen flickering on display devices with heavy image page loading.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer hardware and software. In particular, one or more aspects of the disclosure generally relate to computer hardware and software for optimizing page loading speed while preventing flickering of user interface displays.

An image processing platform may be configured to reduce user interface screen flickering and improve page loading speed. An image processing platform may process images based on determined image complexity. A decision engine may determine the number of image splits and type of parallel processing for an image. The determined image complexity may be based on a determined image complexity score. The system may include machine learning in connection with the decision engine results.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative computing environment for processing images based on complexity in accordance with one or more aspects described herein;

FIG. 2 shows an illustrative image processing platform in accordance with one or more aspects described herein;

FIG. 3 shows an illustrative flow diagram of a computing environment for processing images in accordance with one or more example arrangements described herein;

FIG. 4 shows an illustrative table illustrating factors for determining complexity of images in accordance with one or more aspects described herein; and

FIG. 5 shows a method of image processing in accordance with one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

Computer machines can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Various aspects of this disclosure relate to devices, systems, and methods for processing images to reduce flickering and improve page loading speed. An image processing platform may process images based on determined image complexity. A decision engine may determine the number of image splits and type of parallel processing to be executed on the split images. The determined image complexity may be based on a determined image complexity score. The system may include machine learning in connection with the decision engine results.

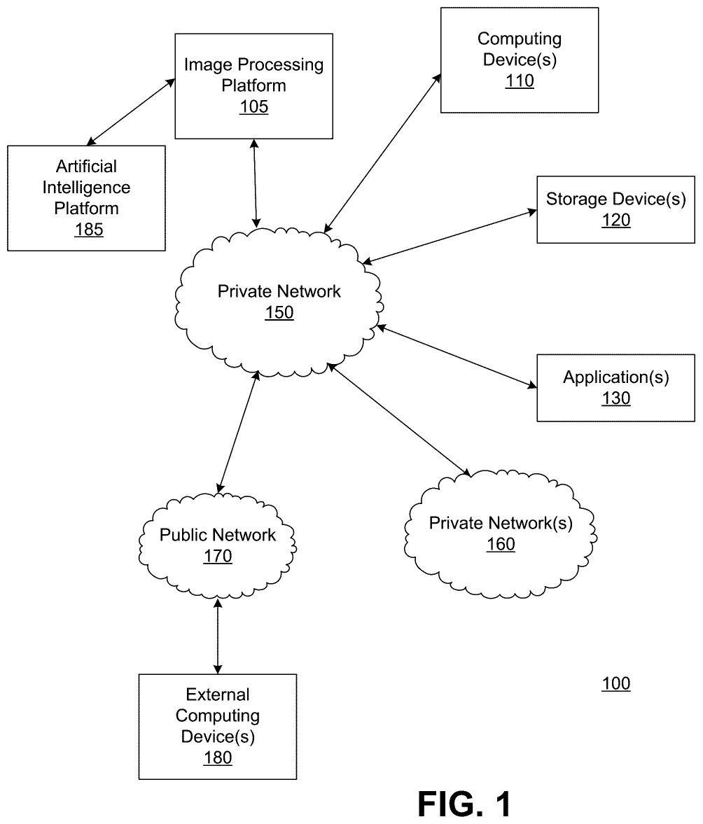

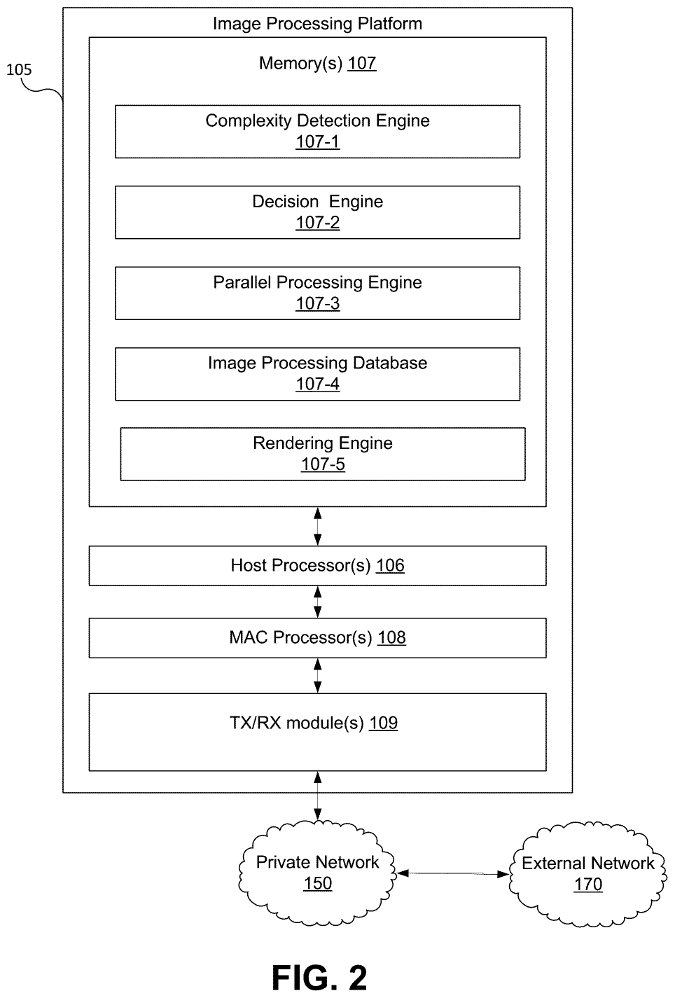

FIGS. 1 and 2 depict an illustrative computing environment for image processing in accordance with one or more example arrangements. Referring to FIG. 1, a computing environment 100 may comprise one or more devices (e.g., computer systems, communication devices, servers). The computing environment 100 may comprise, for example, an image processing platform 105, computing device(s) 110, and storage device(s) 120 linked over a private network 150. The storage device(s) 120 may comprise a database, for example, a relational database (e.g., Relational Database Management System (RDBMS), Structured Query Language (SQL), etc.). Application(s) 130 may operate on one or more computing devices or servers associated with the private network 150. The private network 150 may comprise an enterprise private network, for example.

The computing environment 100 may comprise one or more networks (e.g., public networks and/or private networks), which may interconnect with the image processing platform 105, the computing device(s) 110, the storage device(s) 120, and/or one or more other devices and servers. One or more applications 130 may operate on one or more devices in the computing environment. The networks may use wired and/or wireless communication protocols. The private network 150 may be associated with, for example, an enterprise organization. The private network 150 may interconnect the image processing platform 105, the computing device(s) 110, the storage device(s) 120, and/or one or more other devices/servers which may be associated with the enterprise organization. The private network 150 may be linked to other private network(s) 160 and/or a public network 170. The public network 170 may comprise the Internet and/or a cloud network. The private network 150 and the private network(s) 160 may correspond to, for example, a LAN, a WAN, a peer-to-peer network, or the like.

A user in a context of the computing environment 100 may be, for example, an associated user (e.g., an employee, an affiliate, or the like) of the enterprise organization. An external user may utilize services being provided by the enterprise organization, and access one or more resources located within the private network 150 (e.g., via the public network 170). Users may operate one or more devices in the computing environment 100 to send messages to and/or receive messages from one or more other devices connected to the computing environment 100. An enterprise organization may correspond to any government or private institution, an educational institution, a financial institution, health services provider, retailer, or the like.

As illustrated in greater detail below, the image processing platform 105 may comprise one or more computing devices configured to perform one or more of the functions described herein. The image processing platform 105 may comprise, for example, one or more computers (e.g., laptop computers, desktop computers, servers, server blades, or the like).

The computing device(s) 110 may comprise one or more of enterprise application host platforms, an enterprise user computing device, an administrator computing device, and/or other computing devices, platforms, and servers associated with the private network 150. The enterprise application host platform(s) may comprise one or more computing devices and/or other computer components (e.g., processors, memories, communication interfaces). The enterprise application host platform may be configured to host, execute, and/or otherwise provide one or more enterprise applications. The enterprise application host platform(s) may be configured, for example, to host, execute, and/or otherwise provide one or more transaction processing programs, user servicing programs, and/or other programs associated with an enterprise organization. The enterprise application host platform(s) may be configured to provide various enterprise and/or back-office computing functions for an enterprise organization. The enterprise application host platform(s) may comprise various servers and/or databases that store and/or otherwise maintain account information, such as financial/membership account information including account balances, transaction history, account owner information, and/or other information corresponding to one or more users (e.g., external users). The enterprise application host platform(s) may process and/or otherwise execute transactions on specific accounts based on commands and/or other information received from other computer systems comprising the computing environment 100. The enterprise application host platform(s) may transmit and receive data from the image processing platform 105, and/or to other computer systems in the computing environment 100.

The application(s) 130 may comprise transaction processing programs, user servicing programs, and/or other programs associated with an enterprise organization. The application(s) 130 may correspond to applications that provide various enterprise and/or back-office computing functions for an enterprise organization. The application(s) 130 may correspond to applications that facilitate storage, modification, and/or maintenance of account information, such as financial/membership account information including account balances, transaction history, account owner information, and/or other information corresponding to one or more users (e.g., external users). The application(s) 130 may process and/or otherwise execute transactions on specific accounts based on commands and/or other information received from other computer systems comprising the computing environment 100. The application(s) 130 may operate in a distributed manner across multiple computing devices (e.g., the computing device(s) 110) and/or servers, operate on a single computing device and/or server. The application(s) 130 may be used for execution of various operations corresponding to the one or more computing devices (e.g., the computing device(s) 110) and/or servers.

The storage device(s) 120 may comprise various memory devices such as hard disk drives, solid state drives, magnetic tape drives, or other electronically readable memory, and/or the like. The storage device(s) 120 may be used to store data corresponding to operation of one or more applications within the private network 150 (e.g., the application(s) 130), and/or computing devices (e.g., the computing device(s) 110). The storage device(s) 120 may receive data from the image processing platform 105, store the data, and/or transmit the data to the image processing 105 and/or to other computing systems in the computing environment 100.

The architecture of the private network(s) 160 may be similar to an architecture of the private network 150. The private network(s) 160 may correspond to, for example, another enterprise organization that communicates data with the private network 150. The private network 150 may also be linked to the public network 170. The public network 170 may comprise the external computing device(s) 180. The external computer device(s) 180 may include at least one computing device (e.g., desktop computer, laptop computer) or mobile computing device (e.g., smartphone, tablet). The external computer device(s) 180 may be linked to and/or operated by a user (e.g., a client, an affiliate, or an employee) of an enterprise organization associated with the private network 150. The user may interact with one or more enterprise resources while using the external computing device(s) 180 located outside of an enterprise firewall.

The image processing platform 105, the computing device(s) 110, the external computing device(s) 180, and/or one or more other systems/devices in the computing environment 100 may comprise any type of computing device capable of receiving input via a user interface, and may communicate the received input to one or more other computing devices. The image processing platform 105, the computing device(s) 110, the external computing device(s) 180, and/or the other systems/devices in the computing environment 100 may, in some instances, comprise server computers, desktop computers, laptop computers, tablet computers, smart phones, wearable devices, finger print readers, entryway scanners, or the like that in turn comprise one or more processors, memories, communication interfaces, storage devices, and/or other components. Any and/or all of the image processing platform 105, the computing device(s) 110, the storage device(s) 120, and/or other systems/devices in the computing environment 100 may be, in some instances, special-purpose computing devices configured to perform specific functions.

In some embodiments, artificial intelligence or machine learning may be used with image processing platform 105. As shown if FIG. 1, image processing platform 105 may directly communicate and work with artificial intelligence platform 185. In some instances, artificial intelligence platform 185 may comprise a Long Short-Term Memory (LSTM) neural network that may be used to monitor current and past image processing of images. In other instances, deep scanning may be used to analyze history and frequency of particular images being processed. The use of machine learning and the analysis of image processing history may speed up processing, increase page loading speed, and reduce overall user interface flickering.

Referring to FIG. 2, the image processing platform 105 may comprise one or more of host processor(s) 106, memory 107, medium access control (MAC) processor(s) 108, transmit/receive (TX/RX) module(s) 109, or the like. One or more data buses may interconnect host processor(s) 106, memory 107, MAC processor(s) 108, and/or TX/RX module(s) 109. The image processing platform 105 may be implemented using one or more integrated circuits (ICs), software, or a combination thereof, configured to operate as discussed below. The host processor(s) 106 and the MAC processor(s) 108 may be implemented, at least partially, on a single IC or multiple ICs. Memory 107 may be any memory such as a random-access memory (RAM), a read-only memory (ROM), a flash memory, or any other electronically readable memory, or the like.

One or more processors (e.g., the host processor(s) 106, the MAC processor(s) 108, and/or the like) of the image processing platform 105 may be configured to execute machine readable instructions stored in memory 107. Memory 107 may comprise (i) one or more program modules/engines having instructions that when executed by the one or more processors cause the image processing platform 105 to perform one or more functions described herein, and/or (ii) one or more databases that may store and/or otherwise maintain information which may be used by the one or more program modules/engines and/or the one or more processors. The one or more program modules/engines and/or databases may be stored by and/or maintained in different memory units of the image processing platform 105 and/or by different computing devices that may form and/or otherwise make up the image processing platform 105. For example, memory 107 may have, store, and/or comprise a complexity detection engine 107-1, decision engine 107-2, parallel processing engine 107-3, and image processing database 107-4. The decision engine 107-2 may comprise instructions that direct and/or cause the image processing platform 105 to perform one or more operations, as discussed in greater detail below. The image processing database 107-4 may comprise a SQL database, an Oracle database, or another relational database, for example. The image processing database 107-4 may store information to be used for performing additional image processing by image processing platform 105.

While FIG. 2 illustrates the image processing platform 105 as being separate from other elements connected in the private network 150, in one or more other arrangements, the image processing platform 105 may be included in one or more of the computing device(s) 110, and/or other device/servers associated with the private network 150. Elements in the image processing platform 105 (e.g., host processor(s) 106, memory(s) 107, MAC processor(s) 108, and TX/RX module(s) 109, one or more program modules and/or stored in memory(s) 107) may share hardware and/or software elements with and corresponding to, for example, one or more of the computing device(s) 110, and/or other devices/servers associated with the private network 150.

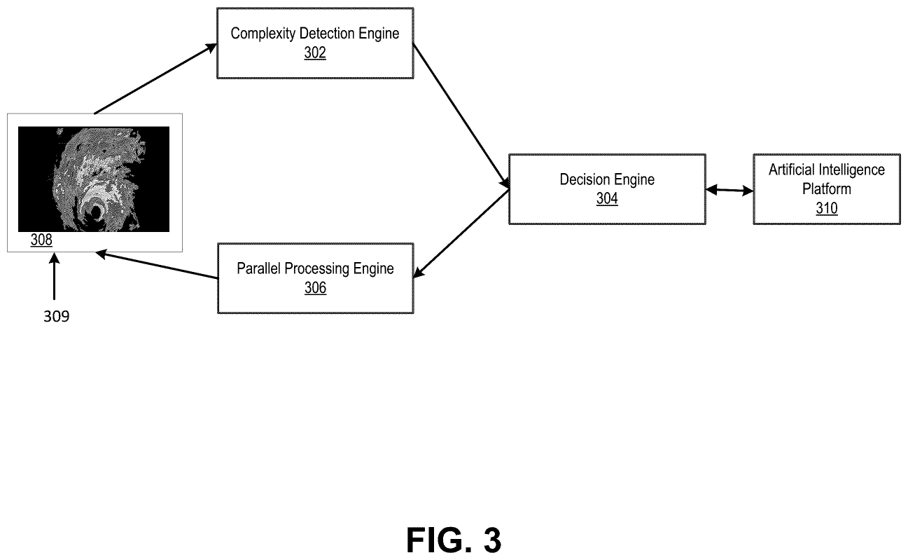

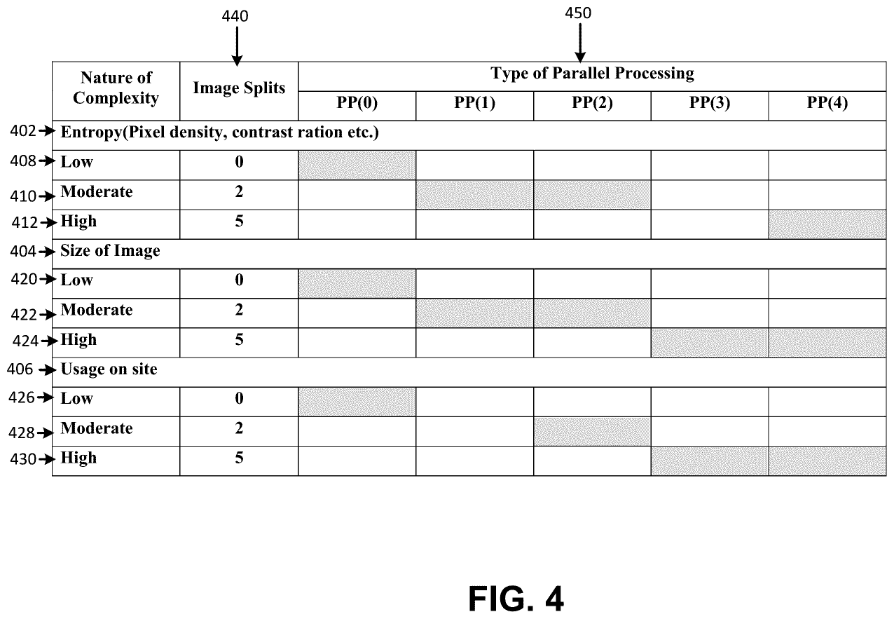

FIG. 3 shows an illustrative flow diagram of a computing environment for image processing in accordance with one or more aspects of the disclosure. In FIG. 3, complexity detection engine 302 determines an image complexity score for content to be rendered onto a user interface screen. FIG. 4 illustrates a number of factors complexity detection engine 302 may utilize in determining nature of complexity of a selected image.

Complexity detection engine 302 determines the complexity of an image based on a number of complexity factors that may include entropy 402, size of image 404, and usage on site 406. Those skilled in the art will realize that numerous additional complexity criteria may be used to determine the complexity of an image. For instance, complexity criteria may also include determination of color combinations used in an image. Different color combinations used in an image may be easier to process than other color combinations.

In an aspect of the disclosure, entropy 402 of an image may include the pixel density and contrast ratio along with other parameters. In an embodiment, the entropy 402 of an image may be determined to be low 408, moderate, 410, or high 412 by complexity detection engine 302.

In an aspect of the disclosure, size of image 404 may be determined to be low 420 (below 500 kb), moderate 422 (above 500 kb but below 2 Mb), or high (above 2 Mb). Those skilled in the art will realize that other ranges may be used based on the type of images being processed and those different ranges fall within the scope of the current disclosure.

In yet another aspect of the disclosure, the number of times an image is used on a site 406 may also be a factor in determining image complexity. For instance, some images may be used as background in other images and may be shown in numerous instances on single user interface rendering. In an embodiment, usage on a site of an image may be categorized into low 426, moderate 428, or high 430.

Complexity detection engine 302 may combine the determined subscores of each of the complexity factors to determine an overall complexity score for the image. In an embodiment, the total complexity score for an image may range numerically from one to ten and be stored in image processing database 107-4.

As illustrated in FIG. 3, decision engine 304 based on the generated complexity detection engine's score may determine a number of partitions for an image along with a parallel processing type. FIG. 4 illustrates an exemplary number of image splits 440 and the types of parallel processing 450 that may be determined for use by decision engine 304 for various complex images.

In an aspect of the disclosure, artificial intelligence platform 310 may determine that based on certain criteria a different number of image splits or parallel processing type may be more beneficial to be used based on learnings from earlier decision engine 304 determinations. Artificial intelligence platform 310 and decision engine 304 may be based on discovered learnings determine best outcomes for image processing of various images having similar complexity attributes. These learnings may be implemented to improve page loading speed while reducing user interface flickering. In addition, in situations where two types parallel processing types may be selected based on a determined complexity score, artificial intelligence platform 310 learnings may be utilized to select the parallel processing type with the highest probability of having the best outcome for page loading speed and reduced user interface flickering.

In an aspect of the disclosure, artificial intelligence platform 310 may store and review page loading speeds of images using different determined number of partitions and parallel processing types. Such information may be used to determine future image splits and parallel processing types.

As further illustrated in FIG. 3, parallel processing engine 306 may process the determined parallel processing type to render via rendering engine 107-5 the image 308 without flickering on the user interface display 309 with an acceptable page loading speed. In an aspect of the disclosure, when an update to an image is made or requested the image processing technique of the present disclosure begins again and proceeds through the image processing engines 302, 304, and 306 discussed above to render an updated image on the user interface display 309.

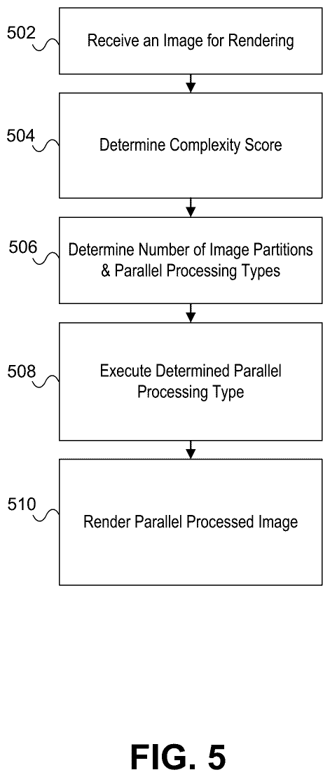

FIG. 5 shows a method of image processing in accordance with one or more aspects of the disclosure. In FIG. 5 at step 502, an image is received that is to be rendered on user interface display 309. In step 504, complexity detection engine 302 determines a complexity score for the image. In step 506, decision engine 304 determines the number of partitions the image should be segmented into for processing. Additionally, decision engine 304 determines the type of parallel processing to be performed on the image partitions based at least in part on the determined complexity score. In step 508, parallel processing engine 306 executes the determined parallel processing type. In step 510, the processed image is rendered on user interface display 309.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. An apparatus comprising:
at least one processor; and
memory storing computer-readable instructions that, when executed by the at least one processor, cause the apparatus to:
receive an image to be rendered on a user interface display;
determine, by a detection engine, a complexity score for the received image;
determine, by a decision engine, a number of image partitions for the received image and type of parallel processing to be performed on the received image based on at least in part the determined complexity score; and
execute, by a provisioning engine, the determined type of parallel processing on the received image.

2. The apparatus of claim 1, wherein the memory further stores computer-readable instructions that, when executed by the at least one processor, cause the apparatus to: render, by a rendering engine, the parallel processed image on the user interface display.

3. The apparatus of claim 2, wherein the memory further stores computer-readable instructions that, when executed by the at least one processor, cause the apparatus to:
receive an updated image to be rendered on the user interface display;
determine, by the detection engine, an updated complexity score for the received updated image;
determine, by the decision engine, a number of image partitions for the received updated image and type of parallel processing to be performed on the received updated image based on at least in part the updated determined complexity score; and
execute, by the provisioning engine, the determined type of parallel processing on the received updated image.

4. The apparatus of claim 1, wherein the memory further stores computer-readable instructions that, when executed by the at least one processor, cause the apparatus to: render, by the rendering engine, the parallel processed updated image on the user interface display.

5. The apparatus of claim 1, wherein the complexity score comprises complexity subscores determined by the decision engine.

6. The apparatus of claim 5, wherein the complexity subscores comprises an entropy subscore.

7. The apparatus of claim 6, wherein complexity subscores comprises a size of image subscore.

8. A method comprising:
receiving an image to be rendered on a user interface display;
determining, by a detection engine, a complexity score for the received image;
determining, by a decision engine, a number of image partitions for the received image and type of parallel processing to be performed on the received image based on at least in part the determined complexity score; and
executing, by a provisioning engine, the determined type of parallel processing on the received image.

9. The method of claim 8, further comprising rendering the parallel processed updated image on the user interface display.

10. The method of claim 8, wherein the complexity score comprises complexity subscores determined by the decision engine.

11. The method of claim 10, wherein the complexity subscores comprises an entropy subscore.

12. The method of claim 10, wherein complexity subscores comprises a size of image subscore.

13. The method of claim 10, wherein the complexity subscores comprises a usage on site subscore.

14. The method of claim 8, further comprising:
analyzing, by an artificial intelligence platform, the determined number of image partitions and type of parallel processing; and
updating the determined number of image partitions and type of parallel processing based on the analysis.

15. Non-transitory computer readable media storing instructions that, when executed by a processor, cause an apparatus to:
receive an image to be rendered on a user interface display;
determine, by a detection engine, a complexity score for the received image;
determine, by a decision engine, a number of image partitions for the received image and type of parallel processing to be performed on the received image based on at least in part the determined complexity score; and
execute, by a provisioning engine, the determined type of parallel processing on the received image.

16. The non-transitory computer readable media of claim 15, wherein the instructions, cause the apparatus to: render, by a rendering engine, the parallel processed image on the user interface display.

17. The non-transitory computer readable media of claim 15, wherein the instructions, cause the apparatus to:
receive an updated image to be rendered on the user interface display;
determine, by the detection engine, an updated complexity score for the received updated image;
determine, by the decision engine, a number of image partitions for the received updated image and type of parallel processing to be performed on the received updated image based on at least in part the updated determined complexity score; and
execute, by the provisioning engine, the determined type of parallel processing on the received updated image.

18. The non-transitory computer readable media of claim 17, wherein the instructions cause the apparatus to: render, by the rendering engine, the parallel processed updated image on the user interface display.

19. The non-transitory computer readable media of claim 18, wherein the complexity score comprises complexity subscores determined by the decision engine.

20. The non-transitory computer readable media of claim 19, wherein the complexity subscores comprises a usage on site subscore.
